(19) United States
(12) Patent Application Publication
(10) Pub. No.: US 2002/0183048 A1
(43) Pub. Date: Dec. 5, 2002

(54) Portable terminal service method

(75) Inventor: Hideyuki Takeuchi, Tokyo (JP)

Correspondence Address: KANESAKA AND TAKEUCHI, 1423 Powhatan Street, Alexandria, VA, 22314, US

(73) Assignee: KUNI HOLDING INTERNATIONAL INC.

(21) Appl. No.: 09/930,234

(22) Filed: Aug. 16, 2001

(30) Foreign Application Priority Data
Jun. 5, 2001 (JP) 2001-169432

(51) Int. Cl. H04M 3/42

(52) U.S. Cl. 455/414; 455/412; 455/418

(57) ABSTRACT

In a portable terminal service of the invention, audio data are stored in a portable terminal, and during a ringback tone period, that is, from a time when a phone call is made until a time when the other party of the call answers the phone, a content of the audio data is played from a speaker of the portable terminal. Accordingly, the ringback tone period in case of making the call by the portable terminal can be efficiently utilized.

### BACKGROUND OF THE INVENTION AND RELATED ART STATEMENT

The present invention relates to a service which provides sounds, such as an advertisement, from a speaker of a portable terminal of a caller until a receiver of the call answers the phone in case of making a call by utilizing a communication network, such as a telephone line.

Conventionally, in case a caller makes a phone call by using a portable terminal, such as a cellular phone, when the caller finishes pressing dial buttons or keys, a signal is transmitted to a telephone exchange of a communication network provider through the telephone line or the like, so that a ringing signal is sent to a communication terminal, such as a telephone, of a receiver. In response thereto, the communication terminal of the receiver answers the telephone exchange by “ringback tone”, “busy tone” or “network busy tone”. Accordingly, a channel is formed between the portable terminal of the caller and the communication terminal of the receiver, and “ringback tone”, “busy tone”, or “network busy tone” is sent from the telephone exchange to the portable terminal of the caller. By receiving these signals, the caller can be apprised of the condition of the communication terminal of the receiver.

A signal tone replied to the portable terminal, such as the ringback tone, has an important meaning by itself as the signal informing the condition of the communication terminal in the receiver side. However, this signal tone is mechanical, and is not intended to give comforts to sensitivity of the human being. Further, the signal tone does not have any meaning other than the meaning of notifying the condition of the communication terminal.

Various studies have been made to see if the tasteless signal tone can be made comfortable and can have a further meaningful content, and the inventor of the present invention thought of replacing the signal tone with music or various kinds of messages.

The present invention has been made in view of the foregoing, and an object of the invention is to utilize a ringback tone period comfortably and meaningfully by playing voice data or audio data, which are stored in advance in a memory of the portable terminal, instead of the ringback tone from a speaker of the portable terminal during a period from when pushing the dial buttons is finished until the receiver answers the phone in case the receiver is called by using the portable terminal.

Further objects and advantages of the invention will be apparent from the following description of the invention.

### SUMMARY OF THE INVENTION

To achieve the aforementioned object, the present invention provides a portable terminal service method using a communication network, a portable terminal connected to the communication network, and a computer connected to the communication network. In the portable terminal service, the portable terminal includes (1) means for downloading audio data sent from the computer connected to the communication network; and (2) means for playing a content of the audio data from a speaker of the portable terminal for a predetermined time during a period from when pressing dial buttons is finished until when a receiver answers a communication terminal. Also, the computer includes (1) means for cumulatively storing a number of calls of the portable terminal; (2) means for sending out the cumulatively stored number of calls to a provider for the communication network; (3) means for storing a plurality of audio data; (4) means for sending out the stored audio data to the portable terminal and updating the audio data stored in the portable terminal; (5) a database for storing personal information of a holder of the portable terminal; and (6) means for selecting the audio data to be sent out based on the personal information.

In the portable terminal service method, a content of the audio data is played from the speaker of the portable terminal for the predetermined time during the period from when pressing the dial buttons is finished until when the receiver answers the phone, and the number of calls cumulatively stored in the computer is updated. Then, the number of calls stored cumulatively is sent out as data for calculating telephone charges to the provider of the communication network for every predetermined period of time, and the audio data is selected based on the personal information of the holder of the portable terminal in the database from the plurality of audio data stored in the computer for every predetermined period. The selected audio data is sent out to the portable terminal to thereby update the audio data stored in the portable terminal.

### BRIEF DESCRIPTION OF THE DRAWINGS

FIG. 1 is a network diagram showing a structure of a portable terminal service of the present invention.

### DETAILED DESCRIPTION OF THE PREFERRED EMBODIMENT

Hereunder, an embodiment of the invention will be explained with reference to the attached drawing.

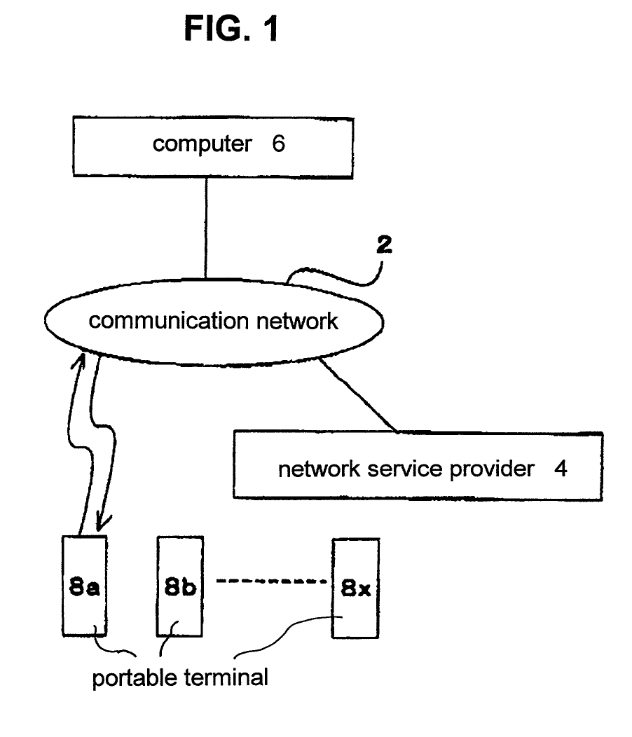

In FIG. 1, numeral 2 designates a communication network, and a telephone exchange, not shown, of a network service provider 4 enables a call between communication terminals, such as portable terminals 8a through 8x, through the communication network 2. As the network service provider, NTT Corp. can be exemplified.

Numeral 6 designates a computer connected to the communication network described above. This computer 6 includes:

(1) means for taking in a number of telephone call times for each registered portable terminal (described later) and cumulatively storing the number in a memory of the computer 6;

(2) means for sending out the number of the telephone calls cumulatively stored in the memory to the communication network provider through the communication network 2 for every predetermined period of time;

(3) means for storing a plurality of audio data;

(4) means for sending out the stored audio data to the portable terminal through the communication network 2 and updating the audio data stored in the portable terminal;

(5) a database for storing personal information of a holder of the portable terminal; and

(6) means for selecting the audio data to be sent out based on the personal information.

Each portable terminal in the aforementioned (1) is required to be registered in the computer 6 in order to receive the service of the invention. Registered contents can be anything as long as the contents, such as a telephone number, can specify the portable terminal.

An interval for sending out cumulative value of the telephone calls in the aforementioned (2) to the communication network provider is not particularly limited, and it is up to a contract between the provider of the service of the invention and the network service provider. For example, it can be every one month.

As the audio data in the aforementioned (3), commercials, various kinds of information, music in various fields can be exemplified. This audio data is adequately updated. An amount of the audio data is an amount having the length which can be finished playing within a period of time while the ringback tone is being sent when the audio is played from a speaker of the portable terminal. More specifically, the length is within fifteen seconds, or preferably, within seven seconds.

As the personal information in the aforementioned (5), age, sex, hobby, occupation and the like are exemplified.

As the method of selecting the audio data in the aforementioned (6), there can be exemplified a selecting method which will select a commercial of cosmetics in case the holder of the portable terminal is a female according to the personal information.

The portable terminal 8 used in the present invention can communicate with other communication terminals, such as portable terminals, stationary telephones, and personal computers, via communication network 2, and includes the following means:

(1) downloading means for downloading the audio data sent from the computer connected to the communicating network; and

(2) means for playing the content of the audio data from the speaker of the portable terminal during a period from when pushing the dial buttons is finished until the other party of the call answers the phone.

The downloading means for downloading the audio data in the aforementioned (1) is a program for downloading the audio data, and stored in the memory of the portable terminal of the caller. In order to store the program, for instance, when the portable terminal is purchased, the program can be stored in the memory at the shop where the portable terminal is purchased.

The means for playing the content of the audio data from the speaker of the portable terminal includes a function of detecting a ringback tone; a function of playing the content of the audio data, which is stored in the memory in advance, instead of the ringback tone from the speaker after the ringback tone is detected; a function which detects a start of conversation by the other party of the call and stops playing the content of the audio data from the speaker to thereby return to the conversation condition; a counting function in which a number of calls in a counter for call times is increased one time in case the content of the audio data is played from the speaker for a predetermined period; and a function of sending the counted number to the computer 6.

Next, there will be explained a case in which the portable terminal service is carried out by using the communication system structured as described above.

Firstly, when inputting a telephone number of the portable terminal 8x of a receiver (person who answers the call) is finished by using the portable terminal 8a owned by the caller (person who makes a phone call), a channel is formed between the portable terminals 8a and 8x by the telephone exchange of the network service provider 4, and a ringback tone of the portable terminal 8x of the receiver is finally sent to the portable terminal 8a of the caller. The portable terminal 8a, which detects the ringback tone, plays the content of the audio data (for example, a commercial) instead of the ringback tone from the speaker for the predetermined period. When the receiver starts the conversation, the start of the conversation is detected so that the playing the content of the audio data is stopped, resulting in the condition in which the normal phone conversation is carried out.

In this case, the number of the calls in the counter of the computer 6 is increased for one time. After these operations are carried out every time the caller makes the phone call, after the predetermined period (for example, one month) has elapsed, the number of the calls by the portable terminal 8a stored in the computer 6 is sent to the network service provider 4.

The number of the calls sent to the network service provider 4 is used as the data for calculating a telephone charge of the portable terminal 8a of the caller, and in case of playing the commercial, the telephone charge of the caller is discounted in accordance with the calculated amount, and charged to the caller.

The discounted calculated amount is paid to the network service provider by a provider of the commercial or the like.

When the predetermined period has elapsed, a plurality of audio data stored in the computer 6 is updated, and updated audio data is sent to the respective portable terminals 8a through 8x.

In this case, the audio data sent to the respective portable terminals are selected by the computer 6. As a basis for selection, the personal data of the holders of the respective portable terminals 8a through 8x stored in the computer 6 are referred to for selection. For example, it is determined whether the commercial is selected or favorite music is selected. Also, sex, age, address, and season can be the basis for selection.

Although the example of the communication between the portable terminals is explained in the aforementioned example, the invention is not limited thereto, and a telephone of the receiver can be a stationary telephone, or a communication terminal, such as a personal computer. Also, the content of the audio data can be the caller's favorite music. In this case, the number of the calls in the counter sent to the network service provider 4 is used as data for calculating a surcharge or additional fee added to the telephone charge to be charged to the caller, and the telephone charge and the surcharge are charged to the caller. The surcharge is paid to a provider of the music data.

According to the present invention, various kinds of audio information is sent to the telephone caller until a receiver answers the phone after the telephone caller makes a phone call, the caller can obtain the useful information instead of listening to the tasteless ringback tone. Also, in case the information is commercial, the telephone charge of the caller can be cheaper.

While the invention has been explained with reference to the specific embodiments of the invention, the explanation is illustrative and the invention is limited only by the appended claims.

What is claimed is:

1. A portable terminal service method using a communication network, a portable terminal connected to the communication network, and a computer connected to the communication network, the method comprising:
storing personal information relative to a holder of said portable terminal in a database in said computer,
playing a content of audio data from a speaker of said portable terminal for a predetermined time during a period from completion of dialing a telephone number from said portable terminal until the called number is answered,
updating a number of calls from said portable terminal cumulatively stored in said computer,
sending out the number of calls stored cumulatively as data for calculating telephone charges to a provider of a communication network for every predetermined period of time,
selecting audio data from a plurality of audio data stored in the computer for every predetermined period, said selected audio data being based on said stored personal information, and
sending out said selected audio data to said portable terminal to thereby update the audio data stored in the portable terminal.

2. A portable terminal service method according to claim 1, wherein said portable terminal includes means for downloading the audio data sent from said computer connected to said communication network, and means for playing the content of the audio data from the speaker of said portable terminal for said predetermined time.

3. A portable terminal service method according to claim 1, wherein said computer includes means for cumulatively storing the number of calls of said portable terminal, means for sending out said cumulatively stored number of calls to said provider for said communication network, means for storing the plurality of audio data, means for sending out said stored audio data to said portable terminal and for updating the audio data stored in the portable terminal, a database for storing the personal information relative to the holder of said portable terminal, and means for selecting the audio data to be sent out based on said stored personal information.
